(19) United States
(12) Patent Application Publication
(10) Pub. No.: US 2016/0120745 A1
(43) Pub. Date: May 5, 2016

(54) PACKAGING

(71) Applicant: Multi Packaging Solutions UK Limited, Nottingham (GB)

(72) Inventors: Carol Lynn Hammond, Nottingham (GB); Nigel Davis, Nottingham (GB)

(21) Appl. No.: 14/919,366

(22) Filed: Oct. 21, 2015

(30) Foreign Application Priority Data
Nov. 3, 2014 (GB) 1419537.4
Sep. 7, 2015 (GB) 1515773.8

(51) Int. Cl. A61J 1/03; B65D 75/36

(52) U.S. Cl. CPC A61J 1/035; B65D 75/36; B65D 2075/361; B65D 2575/363

(57) ABSTRACT

A package includes a first wall panel, a second wall panel attached to one side of the first wall panel, a third wall panel attached to the first side wall panel on the side of the first wall panel opposite the second side wall panel, a blister carrier attached to the side of the second wall panel opposite the first wall panel, and folded over the first wall panel, a cover panel attached to the side of the third wall panel opposite the first wall panel and folded over the blister carrier, first and second end panels attached to opposed ends of the first panel and first and second closure flaps attached to the first and second end panels on the side opposite the first wall panel, and folded over the exterior surface of the cover panel. Each closure flap includes a first portion fixedly adhered to the exterior surface of the cover panel and releasably attached to the adjacent end panel through a first frangible connection, and a second portion releasably attached to the exterior surface of the cover panel through a second frangible connection to the first portion of the closure flap.

This application is entitled to the benefit of, and incorporates by reference essential subject matter disclosed in United Kingdom Application No. 1419537.4 filed on Nov. 3, 2014 and United Kingdom Application No. 1515773.8 filed on Sep. 7, 2015.

### BACKGROUND OF THE INVENTION

1. Technical Field

The present invention relates to child resistant packaging, particularly child resistant pharmaceutical packaging.

2. Background Information

Pharmaceutical products are frequently supplied in blister packs. A blister pack comprises one or more “blisters” which hold capsules, tablets or other items and whose face is sealed by a foil or other film. The blister contents are dispensed by the user pressing down on the blister, thereby pushing the contents of the blister out through the sealing film.

Blister packs are normally supplied in an external package from which they must be removed to allow dispensing of the contents. The present invention seeks to provide a package of this type with improved child resistance and also to provide a level of tamper evidence.

### BRIEF SUMMARY OF THE INVENTION

From a first aspect, the invention provides a package comprising: a first wall panel; a second wall panel attached to one side of the first wall panel; a third wall panel attached to the first side wall panel on the side of the first wall panel opposite the second side wall panel; a blister carrier attached to the side of the second wall panel opposite the first wall panel, and folded over the first wall panel; a cover panel attached to the side of the third wall panel opposite the first wall panel and folded over the blister carrier; first and second end panels attached to opposed ends of the first panel; first and second closure flaps attached to the first and second end panels on the side opposite the first wall panel, and folded over the exterior surface of the cover panel, each closure flap comprising a first portion fixedly adhered to the exterior surface of the cover panel and releasably attached to the adjacent end panel through a first frangible connection, and a second portion releasably attached to the exterior surface of the cover panel through a second frangible connection to the first portion of the closure flap.

The container therefore comprises a blister carrier which is enclosed within the container by a cover panel and folded over closure flaps which are adhered to the cover panel to maintain the cover panel in position. However, when a user wishes to gain access to the blister carrier, he or she must break the releasable attachment between the respective portions of the closure flaps and between the first portion of the closure flap and the adjacent end wall panel to allow the closure flaps to be released from the cover panel to allow the closure panels and the cover panel to be opened. This provides a more secure closure of the container and will also provide a level of tamper evidence since the frangible connection between the respective portions of the closure flaps and the end wall panels must be broken to provide access to the container.

The first portion of the closure flap fixedly secured to the exterior surface of the cover panel may be an end portion of the flap. In a particular embodiment, however, the respective end portions of the closure flap may be fixedly secured to the exterior surface of the cover panel and the second, removable portion of the closure flap be defined between the end portions. This provides a firm attachment of the closure flap to the cover panel, and affords protection to the releasable portion of the closure flap.

The respective frangible connections between the respective portions of the closure flaps and between the first portions of the closure flaps and the end wall panels may take any suitable form, but in a simple embodiment, they may be formed by perforations.

The cover panel may be formed with a tab on its free edge for use in securing the cover panel in position after its initial opening. A tab receiving opening may therefore be defined in an adjacent wall of the container, most particularly in a fold line formed between the blister carrier and the second wall panel.

The blister carrier may be formed as a single panel, simply supporting the blister pack. In a preferred embodiment, however, the carrier may itself provide a level of child resistance. Thus, for example, the carrier may be constructed in accordance with the principles disclosed in GB-A-2451850. In such a construction, a blister pack is slidably received between two panels. One of the panels has an opening for movably receiving a blister of the blister pack. The other panel has one or more dispensing openings aligned with the first panel opening, the first panel and the second panel slidably receiving the blister pack there between. A blocking member is provided which is selectively moveable between a blocking position and a dispensing position. In its blocking position the blocking member prevents movement of the blister into alignment with the dispensing opening, thereby preventing dispensing of the blister's contents through the dispensing opening, but in its dispensing position it permits the blister to be moved into alignment with the dispensing opening for dispensing the blister's contents.

The respective panels of the blister carrier may be joined about a fold line.

The blocking panel may also be attached to one of the blister carrier panels about a fold line. In certain embodiments, that fold line may be located at a side edge or an end edge of one of the blister carrier panels, for example particularly at a side or end edge of the blister carrier panel attached to the second wall panel.

In other embodiments, the blocking member may be slidably retained between the blister carrier panels, for example in a manner similar to that as illustrated in FIG. 3 of GB-A-2451850.

The blister carrier may be formed integrally with the container. However in an alternative embodiment, it may be formed as a separate part therefrom and adhesively secured to another wall of the container. The blister carrier may then be filled with a blister pack before the container is erected. Where separately constructed, the blister carrier may be integrally formed with one or more panels of the container, for example with the second wall panel of the container. A suitable glue flap or the like would be provided on the appropriate panel for attachment purposes.

In certain embodiments, the blister carrier may comprise a sachet attached to the second wall panel and which contains a blister pack.

The sachet may be sealed and may contain, for example, a simple blister strip or a more secure arrangement such as one of those described in GB-A-2451850.

The sachet may be attached directly to the second wall panel, or to a flap attached to the second wall panel.

The sachet material may be a polypropylene, polyethylene, PET or multi-layer laminate structured material.

The sachet may be of a tubular construction sealed at opposed ends, or a dual film envelope or wrap construction sealed on all four sides. The sachet may be attached to the second wall portion or flap at a sealed region.

The sealed region may comprise perforations or other weakening means to allow it to be separated from the second wall portion or flap to facilitate opening.

The sachet may be attached, for example glued or heat sealed the second wall panel or flap before the container is erected.

It will also be appreciated that the invention extends to a blank of cardboard, paperboard or other lightweight foldable sheet material for forming a container in accordance with the invention.

From a further aspect, therefore, the invention provides a blank of paperboard, cardboard or other foldable sheet material, the blank comprising: a first wall panel; a second wall panel hingedly attached to one side of the first wall panel about a first fold line; a third wall panel hingedly attached to the first side wall panel about a second fold line on the side of the first wall panel opposite the second side wall panel; a blister carrier hingedly attached to the side of the second wall panel opposite the first wall panel about a third fold line, and foldable over the first wall panel about the third fold line; a cover panel hingedly attached to the side of the third wall panel opposite the first wall panel about a fourth fold line and foldable over the blister carrier about the fourth fold line; first and second end panels hingedly attached to opposed ends of the first panel about fifth and sixth fold lines; first and second closure flaps hingedly attached to the first and second end panels on the side opposite the first wall panel about seventh and eighth fold lines, and foldable about the seventh and eighth fold lines over the exterior surface of the cover panel, each closure flap comprising a first portion fixedly adherable to the exterior surface of the cover panel and releasably attached to the adjacent end panel through a first frangible connection, and a second portion releasably attached to the first portion through a second frangible attachment to the first portion.

The blank may have any of the relevant optional features described above in relation to the package.

For example, in constructions where the blister is contained in a sachet, the blister carrier may comprise a flap attached to the second wall panel, for receiving the sachet.

### BRIEF DESCRIPTION OF THE DRAWINGS

A preferred embodiment of the invention will now be described by way of example only, with reference to the accompanying drawings.

FIG. 1 shows a blank for a package in accordance with a first embodiment of the invention.

FIGS. 2 to 6 show stages in the erecting of the package from the blank of FIG. 1.

FIGS. 7 and 8 show opening of the package.

FIG. 9 shows a blank for a package in accordance with a second embodiment of the invention.

FIG. 10 shows a blank for a package in accordance with a third embodiment of the invention.

FIG. 11 shows a further embodiment of package in accordance with the invention.

FIG. 12 illustrates a yet further embodiment.

### DETAILED DESCRIPTION OF THE INVENTION

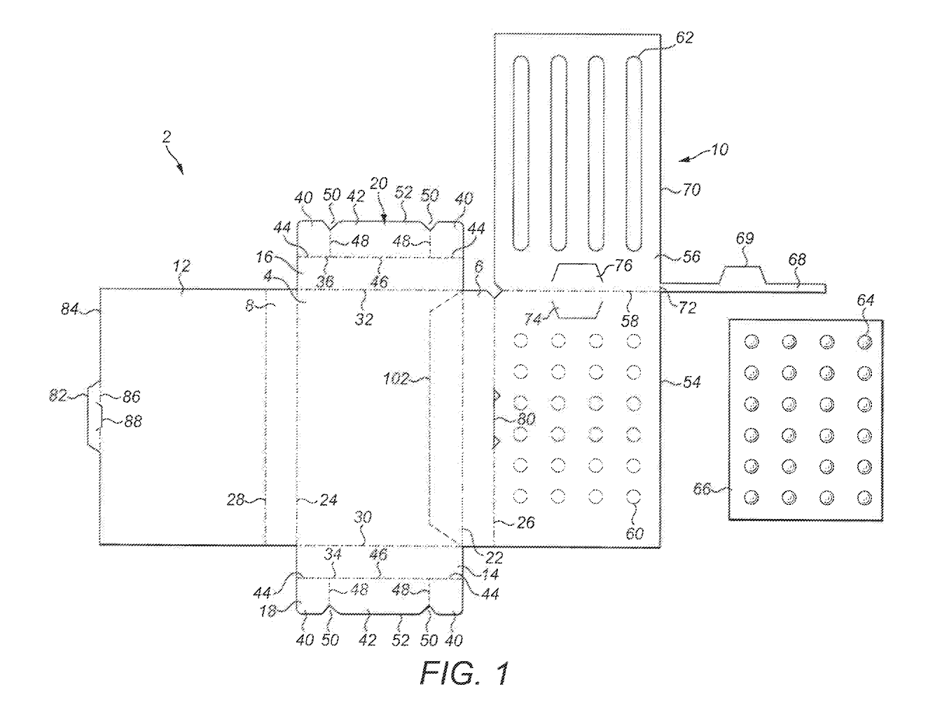

With reference to FIG. 1, a blank 2 for making a package in accordance with a first embodiment of the invention is illustrated. The blank 2 is made from paperboard, cardboard or other lightweight foldable sheet material, as are well known in the packaging art.

The blank 2 comprises a first wall panel 4, a second wall panel 6, a third wall panel 8, a blister carrier 10, a cover panel 12, first and second end panels 14, 16 and first and second closure flaps 18, 20.

The second wall panel 6 is hingedly attached to the first wall panel 4 about a first fold line 22. The third wall panel 8 is hingedly attached to the first wall panel 4 about a second fold line 24 on the opposite side from the second panel 6. The blister carrier 10 (which will be described in greater detail below) is hingedly attached to the second wall panel 6 about a third fold line 26 on a side opposite the first wall panel 4. The cover panel 12 is hingedly connected to the third side wall panel 8 about a fourth fold line 28. The first to fourth fold lines 22-28 are parallel to one another.

The first end panel 14 is hingedly attached to one end of the first wall panel 4 about a fifth fold line 30. The second end panel 16 is hingedly attached to the opposite end of the first wall panel 4 about a sixth fold line 32.

The first closure flap 18 is hingedly attached to the first end panel 14 about a seventh fold line 34. The second closure flap 20 is hingedly attached to the second end panel 16 about an eighth fold line 36. The fifth to eighth fold lines 30-36 are parallel to each other and perpendicular to the first to fourth fold lines 22-28.

Each closure flap 18, 20 has a pair of first, end portions 40 and a second, central portion 42 arranged between the end portions 40. The respective first end portions 40 are connected to the respective adjacent end panel 14, 16 about a first frangible connection 44, in this case a perforated or otherwise weakened section of the seventh and eighth fold lines 34, 36. The respective second central portions 42 of the closure flaps 18, 20 are hingedly connected to the adjacent end panels 14, 16 by unperforated central sections 46 of the seventh and eighth fold lines 34, 36. In addition, the respective second, central regions of the closure flaps 18, 20 are connected to the respective adjacent first, end portions 40 of the closure flaps 14, 16 by a second frangible connection 48 such as a line of weakness, for example perforations 48. A notch 50 is provided in the free edge 52 of each closure flap 18, 20, generally aligned with the second frangible connections 48.

The blister carrier 10 comprises a first blister carrier panel 54 which is hingedly attached to the second wall panel 6 about the third fold line 26. And a second blister carrier panel 56 hingedly attached to the first blister pack carrier panel 54 about a ninth fold line 58.

The first blister carrier panel 54 is formed with a plurality of dispensing openings 60 defined, for example by lines of weakness such as perforations. Providing a cover to the openings 60 in this way provides an additional level of child resistance as the cover has to be removed before the blister contents can be dispensed. The second blister carrier panel 56 has a series of for example four, parallel slots 62. In use, the slots 62 will receive blisters 64 of a blister pack 66, and the dispensing openings 60 align with the blisters 64 of the blister pack 66 when the blister pack 66 is in a dispensing position.

The blister carrier also comprises a blocking element 68 having a blocking tab 69 hingedly attached to one edge 70 of the second blister carrier panel 56 about a tenth fold line 72. Respective tabs 74, 76 are also provided in the first and second blister carrier 54, 56. In alternative embodiments, the blocking element 68 may be attached to the first blister carrier panel 54. In a yet further embodiment, the blocking element may be a separate element inserted into the pack during assembly.

A slot 80 is provided in the third fold line 26 for receiving a tab 82 provided on the free edge 84 of the cover panel 12. The tab 82 is connected to the free edge 84 by an eleventh fold line 86 having a cut region 88.

The erection the package 2 will now be described.

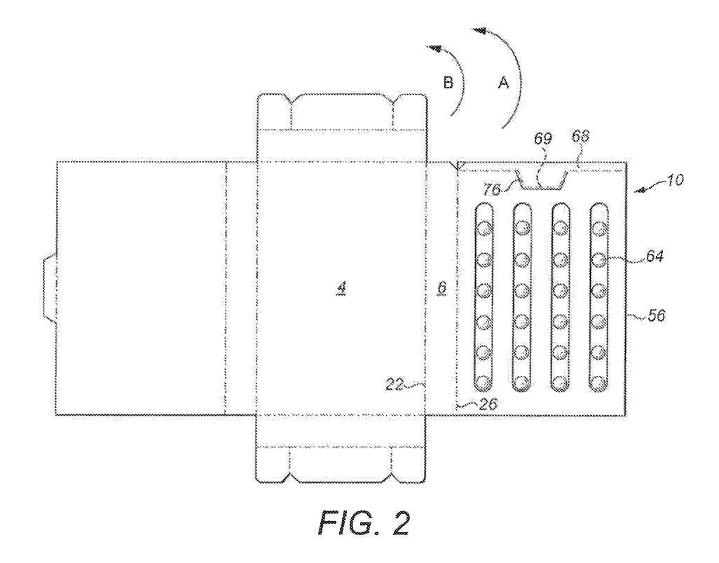

As a first step, the blister pack 66 is mounted to the blister carrier 10 with its blisters 64 aligned with the dispensing openings 60 in the first blister carrier panel 54. The blocking member 68 is then folded about the tenth fold line 72 and adhered to the inner surface of the second blister carrier panel 56 such that its tab 69 lies adjacent an edge of the blister pack 66. The second blister carrier panel 56 is then folded about the ninth fold line 58 and adhered around its periphery to the first blister carrier panel 54. The blisters 64 of the blister pack 66 are received within the slots 62 of the second blister panel 56. This stage is illustrated in FIG. 2.

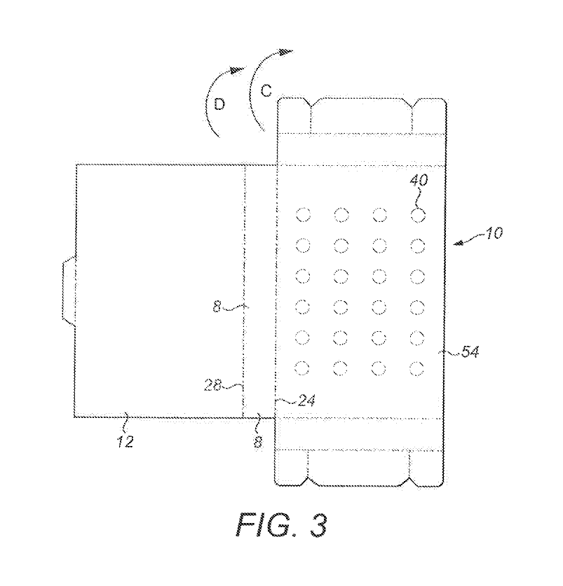

The blister carrier 10 is then folded up about the third fold line 26, as illustrated by arrow A in FIG. 2, and the second wall panel 6 folded about the first fold line 22 as illustrated by arrow B in FIG. 2. After folding, the blister carrier 10 lies over the first panel 4 as illustrated in FIG. 3.

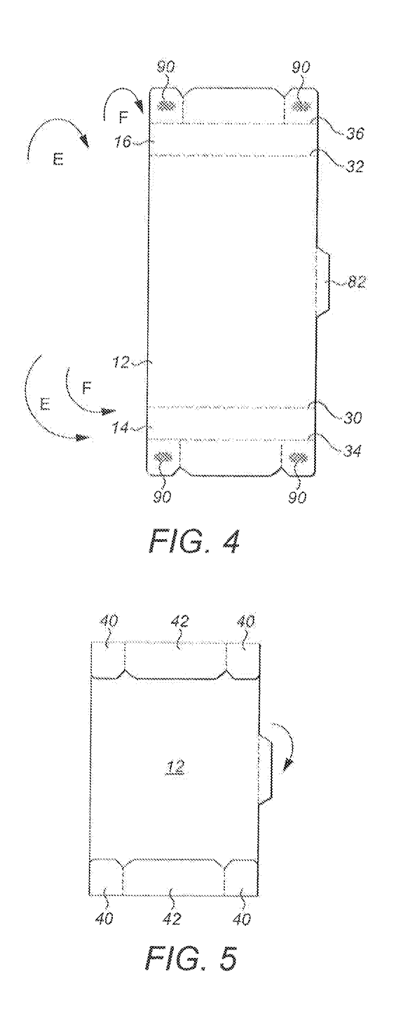

The third wall panel 8 is then folded up about the second fold line 24 as illustrated by the arrow C in FIG. 3 and the cover panel 12 folded about the fourth fold line 28 as illustrated by the arrow D in FIG. 3. After this folding, the cover panel 12 lies over the blaster carrier 10, as illustrated in FIG. 4. The blank 2 is now in a generally tubular configuration.

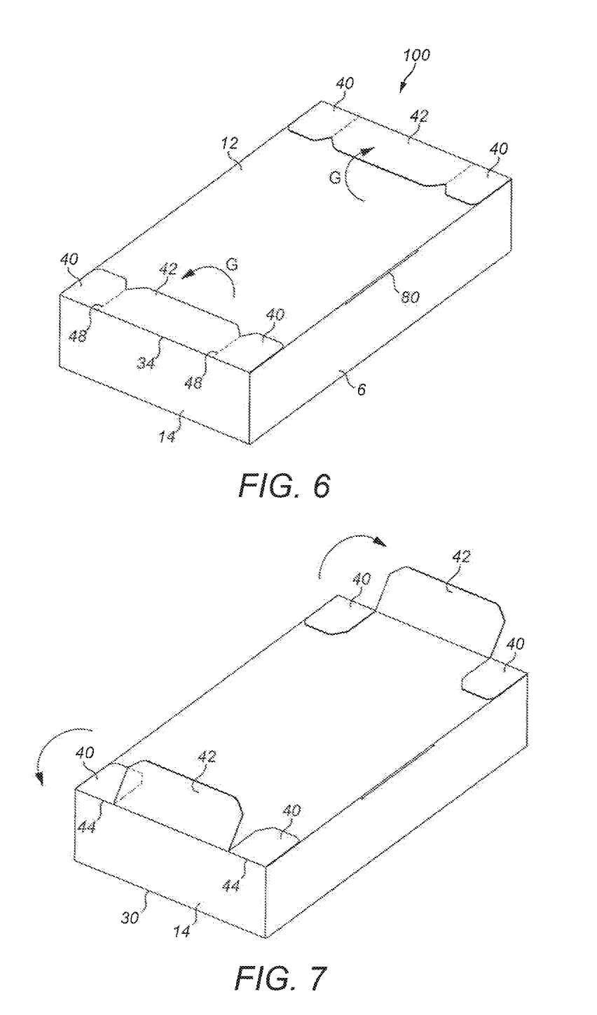

To complete the erection of the package, the end wall panels 14, 16 are folded upwardly about the fifth and sixth fold lines 30, 32 as illustrated by the arrows E in FIG. 4 and the closure flaps 18, 20 folded inwardly about the seventh and eighth fold lines 34, 36, as illustrated by the arrows F in FIG. 4. Adhesive 90 is applied to the inwardly facing surface of only the first, end portions 40 of the closure flaps 18, 20 and the closure flaps 18, 20 then pressed firmly into contact with the cover panel 12, so that the closure flaps 18, 20 become secured to the cover panel at the first end portions 40. The second, central portions 42 of the closure flaps 18, 20 are not adhesively attached to the cover panel 12. The tab 82 on the cover panel 12 may at that point be folded over the eleventh fold line 86 and received in the slot 80 in the third hinge line 26 (although the tab 82 may not be inserted into the slot at this stage, but may be so after first use of the package to keep the package closed). The fully erected package 100 is shown in FIG. 6.

It will be understood that the package 100 is maintained closed by the closure flaps 18, 20 and in order for a user to gain access to the blister pack 66 within the package 100, he or she must break those flaps 18, 20. This will be relatively easily achieved by an adult, but would be rather more difficult for a child.

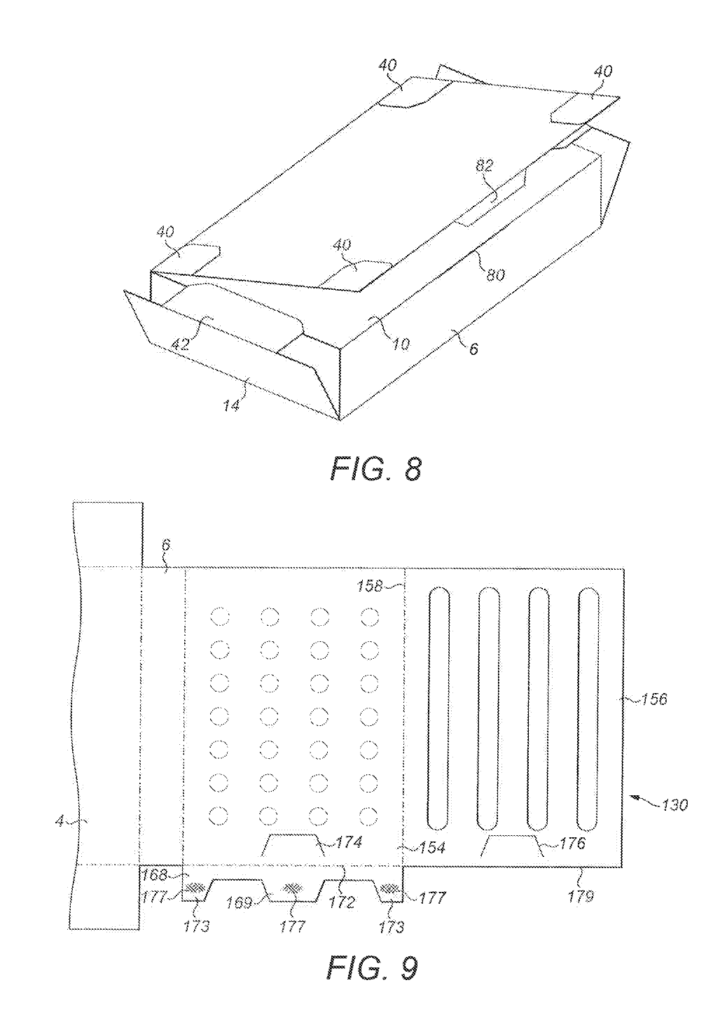

To open the package 100, the user must first insert his or her finger under the free edge 52 of the central portion 42 of each closure flap and pull the central portion 42 upwardly about the respective seventh and eighth hinge lines 34, 36, as illustrated by the arrow G in FIG. 6. This will break the second frangible connection 48 between the central portions 42 of the closure flaps 18, 20 and the first end portions 40 thereof. The user can then use the central portions 42 to pull the end panels 14, 16 away from the package about the fifth and sixth hinge lines 30, 32, as illustrated by the arrows H in FIG. 7 so breaking the first frangible connection 44 between the first end portions 40 of the closure flaps 18, 20 and the end panels 14, 16. This allows the end panels 18, 20 and the cover panel 12 to be folded back as illustrated in FIG. 8 to allow the blister carrier 10 to be accessed. Indeed the package can be folded out to an essentially flat configuration similar to that shown in FIG. 2.

To dispense the contents of the blister pack 66, the user must depress the tab 76 in the second blister carrier panel 56 to thereby deflect the blocking member 68 out of alignment with the edge of the blister pack 66, thereby allowing the blisters 64 of the blister pack 66 to slide along the slots 62 to a position in which individual blisters 64 align with the openings 60 in the first blister carrier panel 54, to allow the blister contents to be dispensed therethrough.

To close the package, the panels may be folded over in a similar manner to erection, but with the central portions 42 of the closure flaps tucked in under the cover panel 12, with the tab 82 received in the slot 80 holding the package closed.

The above embodiment is by way of example only and variations within the scope of the invention will be apparent to the skilled person. In particular, the form of the blister pack carrier 30 may be different, for example as per the examples shown in GB-A-2451850.

For example, with reference to FIG. 9, in another embodiment, a modified blister pack carrier 130 is illustrated, the remainder of the embodiment being the same as in the first embodiment. In this embodiment the blister pack carrier 130 may comprise a first blister carrier panel 154 attached to the second wall panel 6 and a second blister pack panel 156 hingedly connected about a ninth fold line 158. In the embodiment, however, the ninth fold line 158 is parallel to, rather than orthogonal to, the first to fourth fold lines 22-28. Also, the blocking member 168 is connected to an end edge 170 of the first blister carrier panel 154 along a tenth fold line 172. In this case, the blocking tab 169 is formed centrally to the blocking member 168, with additional glue tabs 173 formed on either side thereof. Respective tabs 174, 176 are formed in the first and second blister carrier panels 154, 156 respectively.

In this embodiment, therefore, the blocking member 168 will be folded over the first blister carrier panel 154, and adhered thereto by adhesive 177 arranged on the glue tabs 173 and the blocking tab 169. The blister pack 66 can then be positioned on the first blister carrier panel 154, as in the earlier embodiment, the second blister carrier panel 156 then folded about the ninth fold line 158 and adhered to the first blister carrier panel 154, so as to trap the blister pack 66 there between. Erection of the package then continues as before.

This embodiment may have the advantage that the ninth fold line 158 is parallel to the first to fourth fold lines 22-28, which may facilitate erection. In addition, the blocking member 168 is more robust than that in the first embodiment.

In a further alternative, the blocking member 168 could be attached to the end edge 179 second blister carrier panel 156.

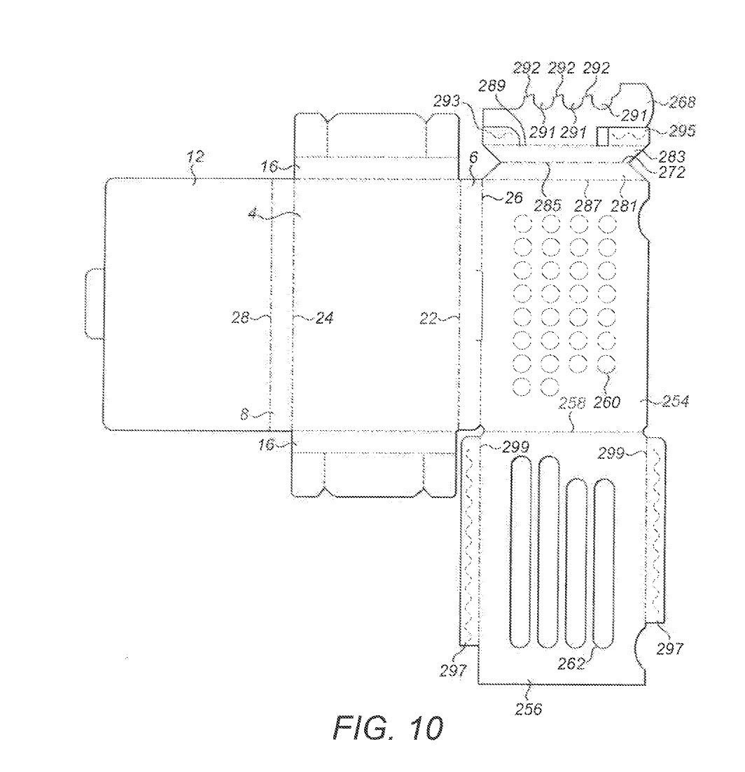

A yet further embodiment is illustrated in FIG. 10. In this embodiment, the main body of the package is the same as in the earlier embodiments, but the blister pack carrier 230 is of a different construction.

In this embodiment, the second blister carrier panel 256 is hingedly attached to the first blister carrier panel 254 about ninth fold line 258, which is arranged at one end of the first blister carrier panel 254. The blocking member 268 is connected to the opposite end of the first blister carrier panel 254 by means of first and second attachment panels 281, 283 and fold lines 285, 287. The blocking member 268 is similar in principle of construction and operation to that shown in FIG. 3 of GB-A-2451850, having recesses 291 for receiving blisters 64 of the blister pack in use, the recesses separated by projections 292. Also attached to the second attachment panel 283 are a pair of glue tabs 293, 295.

The first blister carrier panel 256 is formed with locating flaps 297 along each side edge thereof, attached to the side edges along fold lines 299,

Assembly of this embodiment will now be described. As a first step, the locating flaps 297 are folded about fold lines 299 and adhered to the upper surface of the second blister carrier panel 256. Then blocking member 268, together with glue tabs 293, 295 and the second attachment panel 285 is folded about fold line 285 so as to over lie the face of the first blister carrier panel 254. The glue tabs 293, 295 are glued to the first blister carrier panel 254. The order of these steps may be reversed if desired.

The blister pack 66 may then be positioned on the first blister carrier panel 254, with its blister aligned with the openings 260 in the first blister carrier panel 254. The ends of the projections 292 may help locate the blister pack 66. The second carrier panel 256 is then folded about tenth fold line 258 and adhered to the inner peripheral edges of the first blister carrier panel 254 to trap the blister pack 66 there between. The locating flaps 297 act to locate the edges of the blister pack 66 during its sliding in use.

In an alternative embodiment, where the blocking member 268 is folded over and glued before the locating flaps 297, the blister pack 66 may be located on the first blister carrier panel 254 after the folding and gluing of the blocking member, and before the folding over and gluing of the locating flaps 297.

The blocking member 268 is released from the first blister carrier panel 254 for lateral sliding movement by omitting along the line 289, after the blocking member 268 has been folded over. The cut, which will coincide approximately with fold line 287 will cut through the blocking member 268 and the first blister carrier panel 254 and will separate the first and second attachment panels 281, 283 from the semi-erected blank, freeing the blocking member 268.

The erection of the package then proceeds as in the earlier embodiments.

Also, while the embodiments above illustrates the blister carrier 10 formed integrally with the other panels of the blank, this is not essential. In another embodiments, the blister carrier may be made from a separate blank, for example also possibly including the second wall panel 6 of the package. For example an attachment panel 102 illustrated schematically in dotted lines in FIG. 1 may attach the blister carrier 10 (and second wall panel 6 if present) to the other wall panels. The particular advantage of such an arrangement may be that the blister pack 66 may be assembled into the carrier separately from the erection of the container, even in a different manufacturing location.

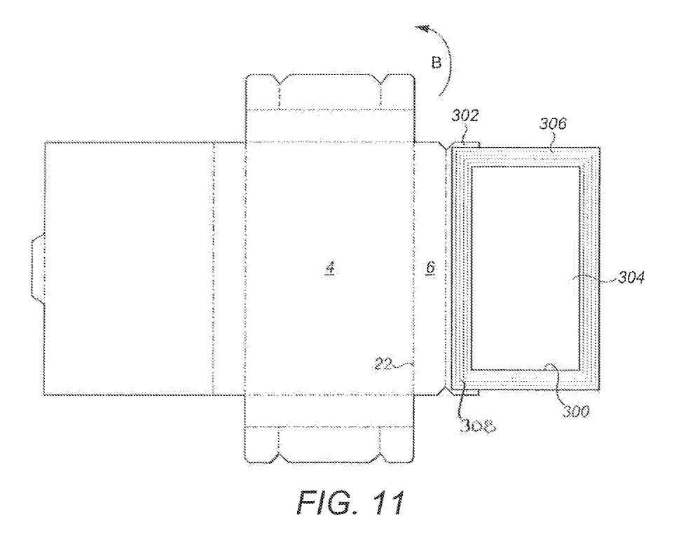

In a further embodiment, illustrated in FIG. 11, a blister carrier 300 incorporates a flap 302 attached to the second side wall panel 6 about fold line 26. Attached to the flap 302 is a sachet 304 which contains a blister pack (not shown), The blister pack may be a simple blister pack (for example similar to the blister pack 66 shown in FIG. 1) or a child resistant blister pack assembly (such as shown for example in GB 2451850).

In this embodiment, the sachet 304 is formed with a peripheral seal 306 which can be opened to provide access to the blister pack within the sachet 304. In an alternative construction, the sachet may be of a tubular construction sealed at opposed ends.

The sachet 304 is attached to the flap 302 at a sealed region 308 by, for example, gluing or heat sealing. The sealed region 308 may comprise perforations or other weakening means to allow the sachet 304 to be removed from the flap 302 to facilitate opening.

The sachet material may be a polypropylene, polyethylene, PET or a multi-layer laminate structured material. The material thickness may be chosen to resist piercing due to contact with the blister pack inside the sachet.

While shown as attached to a separate flap 302, the sachet 304 may, in an alternative construction, be attached directly to the second wall panel 6.

After the sachet 304 has been opened and the blister pack removed, the blister pack may be stored within the container, as the container can still be closed, with the tab 82 received in the slot 80 in the fold line 26.

It should also be understood that the term “attached to” as used herein to describe the attachment of the panels together does not imply a direct connection, the attachment possibly being effected through one or more intermediate panels.

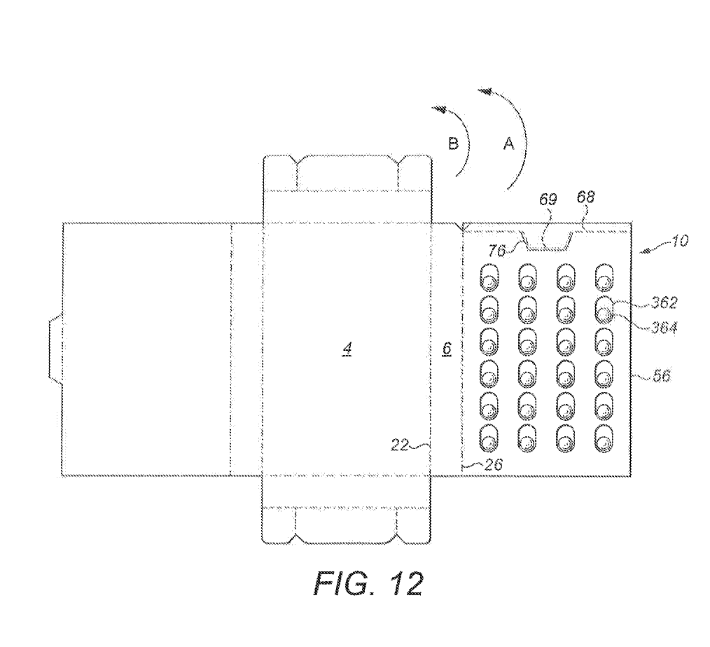

It should also be noted that although continuous slots 62, 162, 262 are illustrated in the embodiments above, it will be appreciated that shorter slots may be provided, for example associated with individual blisters 64. One such arrangement is illustrated in FIG. 12. Here, slots 362 accommodate individual blisters 364 rather than a row of blisters. It has been found that this may enhance child resistance, making it more difficult for a child to try to extract a blister pack via the slots in use.

What is claimed:

1. A package comprising:
a first wall panel;
a second wall panel attached to one side of the first wall panel;
a third wall panel attached to the first side wall panel on the side of the first wall panel opposite the second side wall panel;
a blister carrier attached to the side of the second wall panel opposite the first wall panel, and folded over the first wall panel;
a cover panel attached to the side of the third wall panel opposite the first wall panel and folded over the blister carrier;
first and second end panels attached to opposed ends of the first panel; and
first and second closure flaps attached to the first and second end panels on the side opposite the first wall panel, and folded over the exterior surface of the cover panel, each closure flap comprising a first portion fixedly adhered to the exterior surface of the cover panel and releasably attached to the adjacent end panel through a first frangible connection, and a second portion releasably attached to the exterior surface of the cover panel through a second frangible connection to the first portion of the closure flap.

2. The package as claimed in claim 1, wherein the first portion of the closure flap comprises an end portion of the flap.

3. The package as claimed in claim 2, wherein the first portion of the closure flap comprises respective end portions of the closure flap, the second, removable portion of the closure flap being arranged between and releasably attached to the end portions.

4. The package as claimed in claim 1, wherein the first and/or second frangible connections comprise perforations.

5. The package as claimed in claim 1, wherein the cover panel is formed with a tab on its free edge for use in securing the cover panel in position after its initial opening.

6. The package as claimed in claim 5, wherein a tab receiving opening is defined in the third fold line.

7. The package as claimed in claim 1, wherein the blister carrier comprises first and second blister carrier panels sandwiching a blister pack there between.

8. The package as claimed in claim 7, wherein the first and second blister carrier panels are joined about a fold line.

9. The package as claimed in claim 7, wherein the first blister carrier panel comprises an opening for slidably receiving a blister of the blister pack and the second blister carrier panel comprises one or more dispensing openings aligned with the first panel opening and further comprising a blocking member selectively moveable between a blocking position in which the blocking member prevents movement of the blister into alignment with the dispensing opening and a dispensing position in which it permits the blister to be moved into alignment with the dispensing opening.

10. The package as claimed in claim 9, wherein the blocking member is attached to one of the blister carrier panels about a fold line.

11. The package as claimed in claim 10, wherein the fold line which attaches the blocking member to one of the blister carrier panels is located at a side edge of one of the blister carrier panels.

12. The package as claimed in claim 9, wherein blocking member is slidably mounted between the first and second blister carrier panels.

13. The package as claimed in claim 1 wherein the blister carrier is formed integrally with the package.

14. The package as claimed in claim 1, wherein the blister carrier is formed as a separate part from the package and adhesively secured to a wall of the package.

15. The package as claimed in claim 14 wherein the blister carrier comprises a sachet containing a blister pack.

16. The package as claimed in claim 15 wherein the sachet is attached to a flap attached to the second wall panel.

17. The package as claimed in claim 16 wherein the sachet has a sealed region and is attached to the flap at the sealed region.

18. The package as claimed in claim 17 wherein the sealed region comprises perforations or other weakening means to allow the sachet to be separated from the flap.

19. A blank of paperboard, cardboard or other foldable sheet material, the blank comprising:
a first wall panel;
a second wall panel hingedly attached to one side of the first wall panel about a first fold line;
a third wall panel hingedly attached to the first side wall panel about a second fold line on the side of the first wall panel opposite the second side wall panel;
a blister carrier hingedly attached to the side of the second wall panel opposite the first wall panel about a third fold line, and foldable over the first wall panel about the third fold line;
a cover panel hingedly attached to the side of the third wall panel opposite the first wall panel about a fourth fold line and foldable over the blister carrier about the fourth fold line;
first and second end panels hingedly attached to opposed ends of the first panel about fifth and sixth fold lines; and
first and second closure flaps hingedly attached to the first and second end panels on the side opposite the first wall panel about seventh and eighth fold lines, and foldable about the seventh and eighth fold lines over the exterior surface of the cover panel, each closure flap comprising a first portion fixedly adherable to the exterior surface of the cover panel and releasably attached to the adjacent end panel through a first frangible connection, and a second portion releasably attached to the first portion through a second frangible attachment to the first portion.
